(19) United States
(12) Patent Application Publication
(10) Pub. No.: US 2008/0163822 A1
(43) Pub. Date: Jul. 10, 2008

(54) Pet Waste and Accessory Storage Device

(76) Inventor: Tamara Young Faulkner, Rockville, MD (US)

Correspondence Address: IP Authority, LLC;Ramraj Soundararajan, 4821A Eisenhower Ave, Alexandria, VA, 22304, US

(21) Appl. No.: 11/771,549

(22) Filed: Jun. 29, 2007

Related U.S. Application Data
(60) Provisional application No. 60/806,187, filed on Jun. 29, 2006.

(51) Int. Cl. A01K 29/00

(52) U.S. Cl. 119/161

(57) ABSTRACT

A pet waste and other item storage case is secured to the pet for carrying. Instead of the pet owner/walker carrying a waste bag, they now have the option of the pet carrying a storage case for retaining the waste and/or waste bags himself/herself. In addition, to a waste compartment, other pockets may be included to carry other items including, but not limited to, pet items (e.g. food, water, toys, extra baggies, etc.) or owner's items (e.g. cell phone, keys, etc).

### RELATED APPLICATIONS

This application claims priority benefit of United States provisional patent application 60/806,187 filed Jun. 29, 2006, which is incorporated herein by reference in its entirety.

### BACKGROUND OF THE INVENTION

1. Field of Invention

The present invention relates generally to the field of pet accessories. More specifically, the present invention is related to a pet waste and accessory carrying storage case.

2. Discussion of Prior Art

Strict public standards for disposing of pet waste have forced the average pet owner to carry a plastic bag with them while walking their pet. The owner typically places the waste in the plastic bag and carries it by hand back to their residence for disposal. This can be a humiliating and demeaning experience for the pet owner.

In addition, while walking their pet, the pet may require items such as water, toys, and other items. What is needed is a storage solution for the pet owner.

Whatever the precise merits, features, and advantages of the prior art is, none of them achieves or fulfills the purposes of the present invention.

### SUMMARY OF THE INVENTION

The present invention comprises a pet waste and other item storage case. The case, in a first embodiment, is secured to the pet for carrying and, in a second embodiment is connected to the pet owner either through a hand strap, through or attached to belt loops (i.e. swivel clip). Instead of the pet owner/walker carrying a waste bag, the owner/pet will have the present invention storage case for retaining waste or waste bag secured to them. In addition, to a waste compartment with an optional waste container, other pockets may be included to carry other items, such as but not limited to, pet items (e.g. food, water, toys, etc.) or owner's items (e.g. cell phone, keys, etc).

In one embodiment, the present invention provides a pet waste and accessory storage device comprising: a first partition accessible via a first opening mechanism and providing a first storage area to be used for storage of filled pet waste bags; a second partition accessible via a second opening mechanism and providing a second storage area for storage of accessories; and a retaining mechanism to retain said pet waste and accessory storage device onto a pet. In an extended embodiment, the first storage area contains within a storage container (e.g., a disposable storage container) that is used in the storage of the filled pet waste bags.

In another embodiment, the present invention provides a pet waste and accessory storage device comprising: a first partition accessible via a first zipper and providing a first storage area to be used for storage of filled pet waste bags; a second partition accessible via a second zipper and providing a second storage area for storage of accessories, said accessories storable in said second storage area are any of the following: plastic bags for pet waste storage, towelettes, keys, cell phone, pet toys, or dog treats; and a strap to retain said pet waste and accessory storage device onto a pet, said strap having any of the following: snap lock or swivel hook. In an extended embodiment, the first storage area contains within a storage container (e.g., a disposable storage container) that is used in the storage of the filled pet waste bags.

In yet another embodiment, the present invention also provides for a cylindrical pet waste and accessory storage device comprising: a first zipper disposed in close proximity to a first face of said cylindrical pet waste and accessory storage device, said first zipper when opened revealing a first partition providing a first storage area to contain within a storage container to be used for storage of filled pet waste bags; and a second zipper disposed in close proximity to a second face of said cylindrical pet waste and accessory storage device, said second zipper when opened revealing a second storage area for storage of accessories, said accessories storable in said second storage area are any of the following: plastic bags for pet waste storage, towelettes, keys, cell phone, pet toys, or dog treats; and a strap extending from said first face of said cylindrical pet waste and accessory storage device to said second face of said cylindrical pet waste and accessory storage device, said strap retaining said pet waste and accessory storage device onto a pet via any of the following: a snap lock, a swivel hook, a buckle configuration, or a bayonet clip.

### BRIEF DESCRIPTION OF THE DRAWINGS

FIG. 1 illustrates a simple overview of the present invention's case for carrying pet waste and pet waste accessories.

FIG. 2 illustrates a front view of a two compartment storage case as per the present invention.

FIG. 3 illustrates an exemplary embodiment of the present invention's case for carrying pet waste and pet waste accessories.

FIG. 4a illustrates a snap-lock mechanism that can be used in conjunction with the case of the present invention to retain the same onto a pet.

FIG. 4b illustrates a swivel hook mechanism that can be used in conjunction with the case of the present invention to retain the same onto a pet or person.

FIG. 5 illustrates the present invention's case wherein the opening mechanism, such as a zipper mechanism, is operated to open and reveal the first compartment that holds a storage container.

FIG. 6 illustrates the present invention's case wherein the opening mechanism, such as a zipper mechanism, is operated to open and reveal the second compartment that holds additional items for storage.

FIG. 7 illustrates another view of the present invention's case.

### DESCRIPTION OF THE PREFERRED EMBODIMENTS

While this invention is illustrated and described in a preferred embodiment, the device may be produced in many different configurations, forms and materials. There is depicted in the drawings, and will herein be described in detail, a preferred embodiment of the invention, with the understanding that the present disclosure is to be considered as an exemplification of the principles of the invention and the associated functional specifications for its construction and is not intended to limit the invention to the embodiment illustrated. Those skilled in the art will envision many other possible variations within the scope of the present invention.

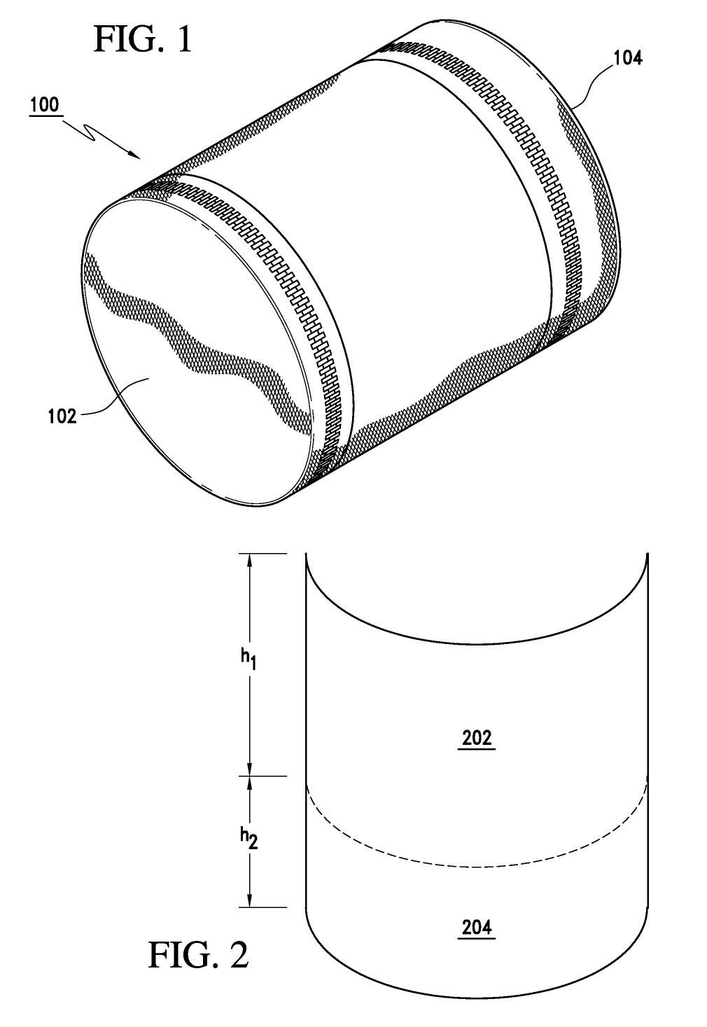

FIG. 1 illustrates a simple overview of the present invention's case 100 for carrying pet waste and pet waste accessories. Case 100, in one embodiment, is cylindrical in shape with the two faces of the cylinder 102 and 104 being part of an opening mechanism that, when opened, reveal a first and second partition or storage area, respectively. Although, case 100 has been illustrated as a cylindrical object in the figures to follow, it should be noted that case 100 can take any shape, without departing from the scope of the present invention. Also, although, case 100 has been illustrated with zipper-based opening mechanisms in the figures to follow, it should be noted that the specific opening mechanism should not be used to limit the scope of the invention.

FIG. 2 illustrates a front view of a two compartment storage case as per the present invention. The case cross-section is round, oval, or oblong in the preferred embodiment, but may be other shapes without departing from the scope of the present invention. For example, the case may be fitted or flexibly fitted to the general shape of the dog's chest/neck area. In the preferred embodiment, the case is partitioned into a first compartment 202 of vertical height h₁ and a second compartment 204 of height h₂, wherein h₁>h₂. In one non-limiting example, h₁=2*h₂.

The first compartment 202 is used for storing filled pet waste bag(s). In one embodiment, the first compartment 202 contains a storage container (e.g., a plastic bowl with lid) used in retaining the filled pet waste bag, or used in storing a water storage device that is used for watering the dog on a walk or run, wherein once the water is emptied, the container is reused to store the filled pet waste bags.

In an extended embodiment, first compartment 202 is designed to accommodate a standard disposable container that can be readily replaced. In the second compartment 204, items such as, but not limited to, extra plastic bags, towelettes, keys, cell phone, dog treats, etc. are stored. Although two storage compartments are shown, the invention should not be limited thereto. Any number or configuration of compartments is within the scope of the present invention.

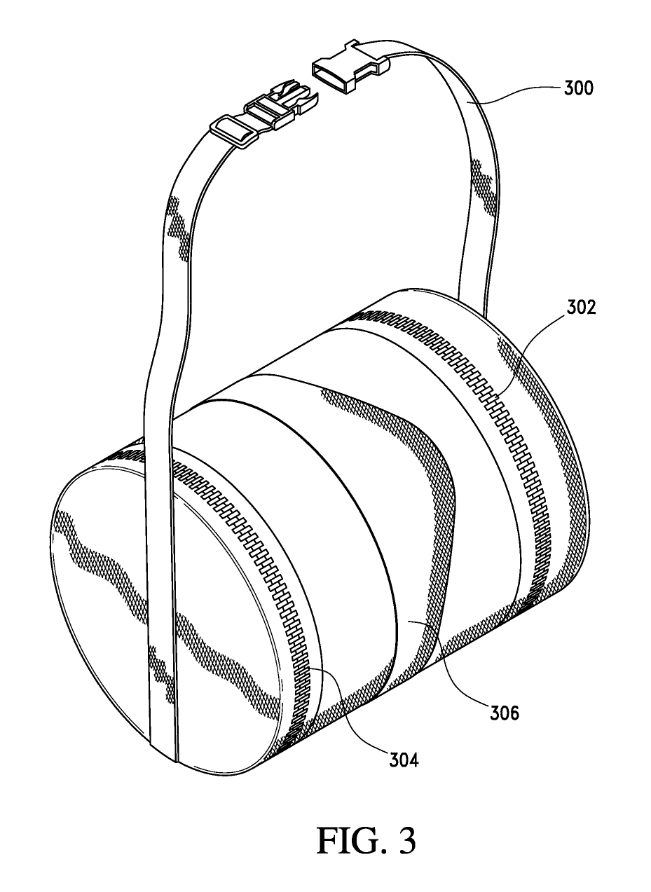

FIG. 3 illustrates an exemplary embodiment of the present invention's case for carrying pet waste and pet waste accessories. In addition to the details of FIG. 1, FIG. 3 also discloses a strap 300. In one particular embodiment, the strap encircles the storage case with a loop remaining at the top for placement around the head/neck of the pet or hand of the pet owner. The strap is adjusted for fit and placement. While shown as configured to go around the pet's neck, placement along the torso may also be envisioned within the scope of the present invention. Zippers 302 and 304 are shown for opening the two storage compartments. In one extended embodiment, a Velcro™ pouch 306 is also provided for storage of additional items.

It should be noted that the present invention's case can be configured to be retained onto a pet via various retaining mechanisms. Although, FIG. 3 illustrates a snap lock retaining mechanism, it should be noted that the present invention should not be limited the specific type of retaining mechanism used should not be used to limit the scope of the present invention. For example, other types of retention falling within the scope of the present invention include, but are not limited to: a buckle configuration, a bayonet clip, a swivel hook, etc.

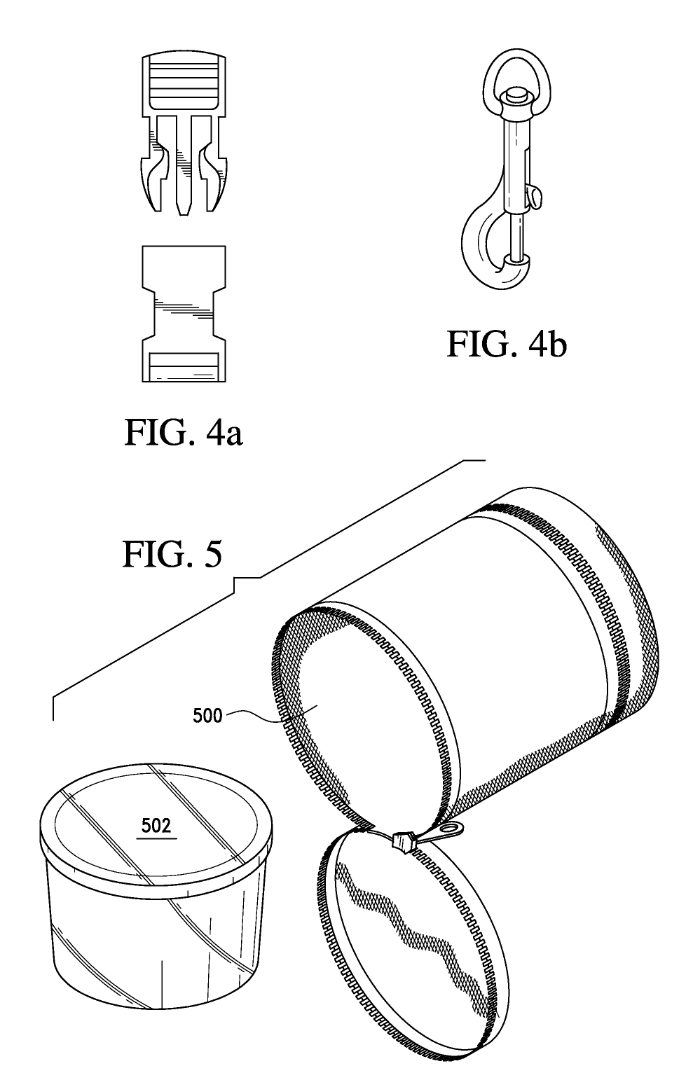

Non-limiting examples of such retaining mechanisms are shown in FIGS. 4a-b. FIG. 4a illustrates a snap-lock mechanism that can be used in conjunction with the case of the present invention to retain the same onto a pet. FIG. 4b illustrates a swivel hook mechanism that can be used in conjunction with the case of the present invention to retain the same onto a pet or person.

FIG. 5 illustrates the present invention's case wherein the opening mechanism, such as a zipper mechanism, is operated to open and reveal the first compartment 500 that holds a storage container 502. The storage container (e.g., a plastic bowl with lid) can be stored for placement of the filled pet waste bag, or be used for watering the dog on a walk or run. In one embodiment, first compartment 500 is specifically designed to accommodate a standard disposable container that can be readily replaced by the user in a cost-effective manner.

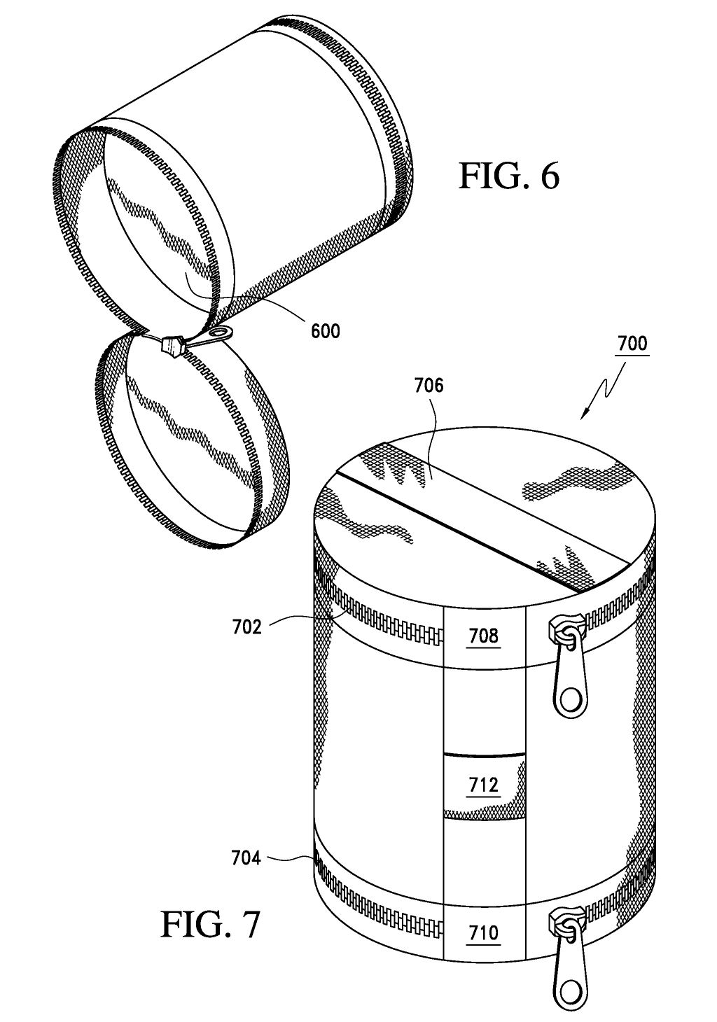

FIG. 6 illustrates the present invention's case wherein the opening mechanism, such as a zipper mechanism, is operated to open and reveal the second compartment 600 that holds additional items for storage. For example, the second compartment 600 can be used to store extra plastic bags, towelettes, keys, cell phone, dog treats, etc. Although two storage compartments are shown, the invention should not be limited thereto. Any number or configuration of compartments is within the scope of the present invention. Also, each partition can be sub-divided into multiple partitions.

FIG. 7 illustrates another view of the present invention's case. Case 700 has two zipper-driven opening mechanisms 702 and 704 to open each face of the cylindrical case. Zipper-driven opening mechanisms 702 and 704, when opened, reveal a first and second partition or storage area, respectively. Element 706 represents the strap, which can be optionally present. It should once again be emphasized that case 700 has been illustrated as a cylindrical object, however, it should be noted that case 700 can take any shape, without departing from the scope of the present invention. It should also be emphasized that, although, case 700 has been illustrated with zipper-based opening mechanisms in the figures to follow, it should be noted that the specific opening mechanism should not be used to limit the scope of the invention.

As shown, zippers are bidirectional in opening the storage compartments. In addition, areas 708 and 710 contain no zipper. This is designed such that there are no zipper mechanisms present in the neck area of a pet, especially if the case 700 is to be retained to a pet's collar via loop opening 712. Alternatively, the case 700 can be attached to a person's belt via loop opening 712.

### CONCLUSION

A system and method has been shown in the above embodiments for the effective implementation of a pet waste and accessory storage device. While various preferred embodiments have been shown and described, it will be understood that there is no intent to limit the invention by such disclosure, but rather, it is intended to cover all modifications and alternate constructions falling within the spirit and scope of the invention, as defined in the appended claims. For example, the present invention should not be limited by size of the pet waste and accessory storage device, type of retention mechanism, materials used to make the pet waste and accessory storage device, or specific manufacturing techniques used in making the pet waste and accessory storage device.

1. A pet waste and accessory storage device comprising:
a. a first partition accessible via a first opening mechanism and providing a first storage area used for storage of filled pet waste bags;
b. a second partition accessible via a second opening mechanism and providing a second storage area for storage of accessories; and
c. a retaining mechanism to retain said pet waste and accessory storage device onto a pet.

2. The pet waste accessory storage device of claim 1, wherein said first storage area further contains within a storage container that is used for storage of said filled pet waste bags.

3. The pet waste accessory storage device of claim 2, wherein said storage container, prior to being used for storage of filled pet waste bags, contains water used in watering a pet during a walk or run.

4. The pet waste accessory storage device of claim 2, wherein said storage container is a disposable plastic bowl.

5. The pet waste accessory storage device of claim 2, wherein said first storage area is designed to accommodate a standard disposable container that can be readily replaced.

6. The pet waste accessory storage device of claim 1, wherein said accessories storable in said second storage area are any of the following: plastic bags for pet waste storage, towelettes, keys, cell phone, pet toys, or dog treats.

7. The pet waste accessory storage device of claim 1, wherein said first and second opening mechanisms are zippers.

8. The pet waste accessory storage device of claim 1, wherein said retaining mechanism is a strap with any of the following: snap lock, swivel hook, a buckle configuration, or a bayonet clip.

9. The pet waste accessory storage device of claim 1, wherein said retaining mechanism is an opening which can be used to slip in a pet's collar, thereby allowing said pet waste accessory storage device to retained around a pet's neck area.

10. The pet waste accessory storage device of claim 1, wherein said first partition is of height, h₁, and said second partition is of height, h₂, with h₁>h₂.

11. The pet waste accessory storage device of claim 10, wherein h₁=2*h₂.

12. A pet waste and accessory storage device comprising:
a. a first partition accessible via a first zipper and providing a first storage area to be used for storage of filled pet waste bags;
b. a second partition accessible via a second zipper and providing a second storage area for storage of accessories, said accessories storable in said second storage area are any of the following: plastic bags for pet waste storage, towelettes, keys, cell phone, pet toys, or dog treats; and
c. a strap to retain said pet waste and accessory storage device onto a pet, said strap having any of the following: snap lock or swivel hook.

13. The pet waste accessory storage device of claim 12, wherein said first storage area contains within a storage container to be used for storage of said filled pet waste bags.

14. The pet waste accessory storage device of claim 13, wherein said storage container is a disposable plastic bowl.

15. The pet waste accessory storage device of claim 13, wherein said first storage area is designed to accommodate a standard disposable container that can be readily replaced.

16. The pet waste accessory storage device of claim 12, wherein said first partition is of height, h₁, and said second partition is of height, h₂, with h₁>h₂.

17. The pet waste accessory storage device of claim 15, wherein h₁=2*h₂.

18. A cylindrical pet waste and accessory storage device comprising:
a. a first zipper disposed in close proximity to a first face of said cylindrical pet waste and accessory storage device, said first zipper when opened revealing a first partition providing a first storage area to contain within a storage container to be used for storage of filled pet waste bags;
b. a second zipper disposed in close proximity to a second face of said cylindrical pet waste and accessory storage device, said second zipper when opened revealing a second storage area for storage of accessories, said accessories storable in said second storage area are any of the following: plastic bags for pet waste storage, towelettes, keys, cell phone, pet toys, or dog treats; and
c. a strap extending from said first face of said cylindrical pet waste and accessory storage device to said second face of said cylindrical pet waste and accessory storage device, said strap retaining said pet waste and accessory storage device onto a pet via any of the following: a snap lock or a swivel hook.

19. The pet waste accessory storage device of claim 18, wherein said storage container is a disposable plastic bowl.

20. The pet waste accessory storage device of claim 18, wherein said first storage area is designed to accommodate a standard disposable container that can be readily replaced.

21. The pet waste accessory storage device of claim 18, wherein said first partition is of height, h₁, and said second partition is of height, h₂, with h₁>h₂.

22. The pet waste accessory storage device of claim 21, wherein h₁=2*h₂.
